(19) United States
(12) Patent Application Publication
(10) Pub. No.: US 2009/0207471 A1
(43) Pub. Date: Aug. 20, 2009

(54) Automatic Window Tint

(76) Inventor: DeeAnna Melissa Blette, Iowa City, IA (US)

Correspondence Address: DEEANNA BLETTE, 612 E COURT ST STE 1, IOWA CITY, IA, 52240-5012, US

(21) Appl. No.: 12/034,651

(22) Filed: Feb. 20, 2008

(51) Int. Cl. G02F 1/00

(52) U.S. Cl. 359/275; 349/16

(57) ABSTRACT

My invention will be used to cut down utility costs in homes and buildings, be a burglar deterrent, as becoming opaque is one of the features, and replacing car windshield sun blocks as well as blinds in school, buildings, homes, etc. The photosensitivity is manipulated through voltage input. In NYC in January for example, persons would set film to dark mode to activate the darker tint to absorb the heat of the light, whereas white or mirrored mode would be deactivated; visa Versa during the summer in NYC. This is meant to be green as it will cut down utility costs immensely and by being able to manipulate the voltage manually, you set how sensitive the photosensitive film is from no voltage manipulation to opaque.

### SUMMARY OF INVENTION

So not only is this designed to control how much sun will be let through if any, but the burglar deterrent is invaluable. In a home, for example, burglar may try and come in, but since this wonderful invention can be hooked up to the security system, or without it, since it will have it's own source; it will make all windows opaque white, mirrored, or black depending on customer's setting. Burglar will not be able to see in and be discouraged as the homeowner can sneak up on him, and call the police.

Not only would home and car owners benefit from burglary and any maladaptive behavior, skyscrapers, in China, and Japan, and USA, everywhere as all of want to go green to save our sweet earth: this would cut down on utility costs immensely, NYC for example, winter, black, summer, white or mirrored. I'm researching the mirror stuff because I don't know if it will cause more problems or not, but want to add it in just to keep my options open. So keeping your car cool, keeping your home cool, low utilities, the savings that large buildings and schools would save would be astronomical. Also, I want to give a positive charge to the film when or before it's installed, perhaps when manufactured so that cleaning is very low maintenance and will repel dust, dirt, and debris. This of course would comply with the law; for example, you cannot drive with opaque white, mirrored or black tint while driving in most states. There would be preventive maintenance to prevent any trouble, a pamphlet or even setting, not sure yet.

### BACKGROUND OF INVENTION

My mind is wonderful, like my invention. I thought of this, like BAM! It came to me, and I was like, I need to get on this. So Aug. 1, 2005, I was like, I'm sending this out to patent trademark institute of America, Davison, Invent tech, and invent help. They wanted all this money for stuff, which I did not understand. I actually have 12 other inventions, but do not have the resources to put the others up . . . yet. I guess, I'm a bit sensitive to light, and I remember my grandmother, when she lived in Vegas and I would visit during the summers from 10-17 years old, she would have to put the cardboard thing up in front of the windshield, and my butt would always hurt from the seats being hot, and I always thought of it as such a pain and a waste of time. I also remember friends with those ridiculous sound systems that go “BOOM!” 3 blocks away, but how they would get robbed, or some weirdo coming up to person's car when their child was in it. I also recall, when in school, there's always that one person that gets that crack of light because the blinds are bent, or messed up, and it's always right in your eye with no escaping it and class is really hard to concentrate on, especially when teacher is trying to fix it and it's just screwed. The cut cost in utilities was actually more of an accident, when thinking up my invention, but I was like Cool! So I hope you think it's cool too. This should absolutely be the new and glorious standard of every home, business, building, school, mall, box seats, car, and airplane, anything with transparent or translucent materials.

### DETAILED DESCRIPTION OF THE PREFERRED EMBODIMENT

### Field of Invention

This glorious invention is used to keep things cool or out of direct sunlight, cut utility costs, and be used as a criminal or burglar deterrent, as well as being low maintenance cleaning. Homes, buildings, cars, trains, anything with a translucent or transparent material.

### BRIEF DESCRIPTION

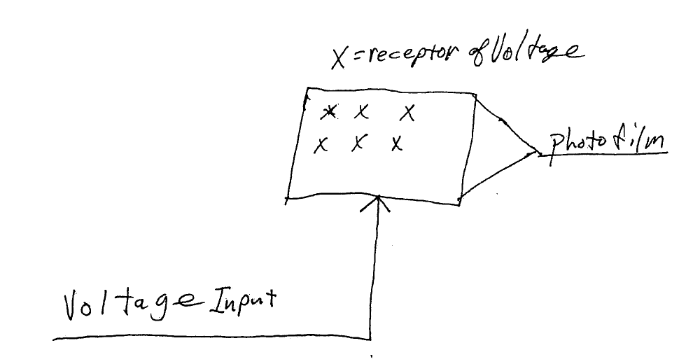

FIG. 1, the only figure, shows how there will be a voltage source that will activate the photosensitive material, which will manipulate the sensitivity of the photosensitive film.

The drawings show the voltage going into the photosensitive film to manipulate depending on users setting, which determines how much, if any voltage is sent to photosensitive film to get desired effect. The ‘X's on the photo film receive the voltage input and hence the film is then activated more than what it would be normally without the voltage. ‘X’s simply receive the input and react by becoming more opaque. Photo is cut to fit on surface for client, whether it's for a windshield in a vehicle, or windows in a house for example. The voltage will most likely be connected to a separate source, perhaps a lithium battery, and then switches over when car is turned on.

1) When activated, the photosensitivity can be manipulated through electricity or a source of voltage.

2) This would replace windshields sun blocks in cars

3) Take the place of blinds in one's home as well as schools, skyscrapers and buildings.

4) Any surface that is transparent or translucent this can benefit, even a VIP box at a baseball game for example.

5) Burglar deterrent in cars and homes for example.

6) Will keep your place/car/school/building, etc. cooler or warmer depending on season and which film you've activated, i.e. summer, white/mirror film to keep cooler, and dark and/or opaque film in winter to absorb sun's energy to keep warmer.

7) What I thought to be convenient is obvious, the part that I didn't think about at first is that this will also cut down on utilities immensely. So it's an energy saver, which means in homes, schools and skyscrapers for example, people will save money on utility bill. It will save you green, while going green simultaneously.

8) I'm also looking at charging the film to repel dust so that cleaning is very low maintenance.
